(19) United States
(12) Patent Application Publication
(10) Pub. No.: US 2015/0004509 A1
(43) Pub. Date: Jan. 1, 2015

(54) LINE DEVICE FOR A FUEL CELL, FUEL CELL AND FUEL CELL STACK

(71) Applicant: Robert Bosch GmbH, Stuttgart (DE)

(72) Inventors: Markus Ketterer, Gerlingen (DE); Sebastian Maass, Renningen-Malmsheim (DE)

(21) Appl. No.: 14/310,712

(22) Filed: Jun. 20, 2014

(30) Foreign Application Priority Data
Jun. 26, 2013 (DE) 10 2013 212 180.6

(51) Int. Cl. H01M 8/04

(52) U.S. Cl. CPC H01M 8/04201
USPC 429/434; 429/514; 429/492; 429/457

(57) ABSTRACT

A line device (1) for a fuel cell (10), having at least one feed section (2) with a feed opening (4), and a removal section (3) with a removal opening (5), wherein the feed section (2) is designed for supplying a fluid to a first side (12) of an active surface (11) of the fuel cell (10) and the removal section (3) is designed for removing the fluid from a second side (13) of the active surface (11) of the fuel cell (10), and the fluid can flow along at least two flow paths (20, 21, 22) from the feed opening (4) through the active surface (11) to the removal opening (5) for the fluid, wherein the feed section (2).

### BACKGROUND OF THE INVENTION

The present invention relates to a line device , having at least one feed section with a feed opening, and a removal section with a removal opening, wherein the feed section is designed for supplying a fluid to a first side of an active surface of the fuel cell and the removal section is designed for removing the fluid from a second side of the active surface of the fuel cell, and the fluid can flow along at least two flow paths from the feed opening through the active surface to the removal opening for the fluid. Furthermore, the invention relates to a fuel cell with an active surface and a line device, the line device at least having a feed section with a feed opening, and a removal section with a removal opening, wherein the feed section is designed for supplying a fluid to a first side of an active surface of the fuel cell and the removal section is designed for removing the fluid from a second side of the active surface of the fuel cell, and the fluid can flow along at least two flow paths from the feed opening through the active surface to the removal opening for the fluid, and also to a fuel cell stack having at least two fuel cells.

Fuel cells, in particular fuel cells operated with pure hydrogen, are applicable nowadays as the drive of the future because of the fact that they emit only pure water as waste product. Fuel cells of this type have an active surface in which the reaction of the hydrogen and therefore the generation of electrical energy take place. In order to provide the fuel cell with fluids, such as, for example, with the fuels required for the reaction or with cooling fluids, said fluids have to be supplied to the fuel cell. For this purpose, line devices which are used for supplying and removing the fluids are provided. The line devices are arranged on the active surface of the fuel cell and therefore form components of the fuel cell in addition to other components of the fuel cell, such as, for example, bipolar plates, current collector plates or end plates.

In order to ensure efficient operation of the fuel cell, fluid which is supplied has to be uniformly distributed within the fuel cell irrespective of whether the fluid is, for example, a fuel or a coolant. FIG. 1 shows an arrangement of a line device 1, which in particular has a feed section 2 and a removal section 3, in a fuel cell 10 according to the prior art. The feed section 2 of the line device 1 here has a feed opening 4 which is directly opposite the first side 12 of the active surface 11 of the fuel cell 10 in the Y direction 23. The removal opening 5 of the removal section 3 of the line device 1 is correspondingly opposite the second side 13 of the active surface 11 in the Y direction 23. By way of example, three flow paths 20, 21, 22, along which the fluid supplied or removed by the line device 1 can flow from the feed section 2 through the active surface 11 to the removal section 3, are shown. It is clearly apparent that the lengths of the three flow paths 20, 21, 22 significantly differ, wherein, in particular, the components of the flow paths 20, 21, 22 cause this difference in the X direction 24. However, the flow path 20, 21, 22 which has the smallest resistance is preferred by the fluid during flow. This resistance is dependent on the length of the flow path 20, 21, 22 as a result of which the fluid flow prefers a flow path 20, 21, 22 which has a shorter length, the flow path 22 in the example shown. As a result, a uniform distribution of the fluid in the active surface 11 of the fuel cell 10 cannot be achieved and also not ensured. According to the prior art, it is known to provide distributing structures 14 in order to prevent these differences in the provision of the active surface 11 with fluid. However, such distributing structures 14 are highly complicated to produce, and, furthermore, are cost-intensive and, moreover, increase the flow resistance for the supplied fluid.

### SUMMARY OF THE INVENTION

It is therefore the object of the present invention at least partially to eliminate the above-described disadvantages of known line devices for fuel cells, of known fuel cells and of fuel cell stacks. In particular, it is the object of the present invention to provide a line device for a fuel cell, a fuel cell and a fuel cell stack, which ensure that an active surface of a fuel cell is uniformly provided with fluid in as simple and cost-effective a manner as possible.

The above object is achieved by a line device for a fuel cell with the features of the invention, by a fuel cell with the features of the invention and by a fuel cell stack with the features of the invention. In this context, the features and details which are described in connection with the line device according to the invention also apply, of course, in connection with the fuel cell according to the invention and the fuel cell stack according to the invention and vice versa in each case, and there is therefore always or can therefore always be a mutual reference with respect to the disclosure of the individual aspects of the invention.

In a first aspect of the invention, the object is achieved by a line device for a fuel cell, having at least one feed section with a feed opening, and a removal section with a removal opening, wherein the feed section is designed for supplying a fluid to a first side of an active surface of the fuel cell and the removal section is designed for removing the fluid from a second side of the active surface of the fuel cell, and the fluid can flow along at least two flow paths from the feed opening through the active surface to the removal opening for the fluid. In particular, a line device according to the invention is characterized in that the feed section and the removal section are arrangeable on the fuel cell in such a manner that the at least two flow paths are identical or substantially identical in length.

By means of the line device according to the invention, the fuel cell on which the line device is arranged can be provided with a fluid. The fluid here can be, for example, a cooling fluid, such as, for example, deionized water or a mixture of water and glycol or a fuel used as reactant. In this connection, the line device according to the invention has at least one feed section and a removal section. The feed section and the removal section here are in particular arrangeable on an active surface of the fuel cell. The arrangement here takes place in particular in such a manner that the feed section is arranged on a first side of the active surface and the removal section is arranged on a second side of the active surface. During operation, the fluid flows out of a feed opening of the feed section. A collecting container in which the fluid is distributed, in particular automatically, can be arranged here between the feed opening and the active surface of the fuel cell. From the first side of the active surface, the fluid flows through the active surface and from a second side of the active surface to a removal opening in the removal section. A collecting container can likewise be provided here between the second side and the removal section. In this context, at least two flow paths which can be brought about in particular by two possibilities of flow through the active surface are possible for the flow of the fluid. Of course, more than two flow paths can also be possible. In this connection, one flow path within the context of the invention is in particular not a possibility of flow predetermined, for example, by line elements, but rather a flow route followed by the fluid without a further line at least outside the active surface. In summary, the fluid flows out of the feed opening of the feed section, through the active surface and again through the removal opening into the removal section and therefore into the line device. In order in particular to ensure that the active surface is uniformly provided with fluid, it is provided according to the invention that the feed section and the removal section are already arrangeable on the fuel cell in such a manner that the lengths of the different flow paths are identical or at least substantially identical. As a result, it can be ensured that the fluid does not flow with particular preference along any of the flow paths. By means of the identical or substantially identical length of the flow paths, it can be ensured that, irrespective of other, length-independent factors, the probability of the passage of the fluid is identical or substantially identical for all of the flow paths. In particular, the flow can thereby flow uniformly along all of the possible flow paths. By means of the arrangement according to the invention of the feed section and of the removal section on the fuel cell, it can be ensured solely by means of this arrangement that the fluid is uniformly distributed in the active surface of the fuel cell. Complicated distributing structures can thus be avoided. Overall, a line device according to the invention constitutes a particularly simple and cost-effective manner of providing a fuel cell uniformly with a fluid.

In the case of the line device according to the invention, it can furthermore be provided that the feed opening has the same or substantially the same width as the first side of the active surface and the removal opening has the same or substantially the same width as the second side of the active surface, and therefore the feed section and the removal section are arrangeable on the active surface in such a manner that the feed opening is arrangeable parallel or substantially parallel to the first side of the active surface and the removal opening is arrangeable parallel or substantially parallel to the second side of the active surface. The feed section of the line device is therefore in each case directly opposite the first side of the active surface and the removal section of the line device is in each case directly opposite the second side of the active surface. The fluid can flow uniformly out of the line device via the entire width of the feed opening in the direction of the first side of the fuel cell. After flowing through the active surface, the fluid can also again flow into the removal section via the entire width of the removal opening. In this manner, it can be particularly simply ensured that all of the possible flow paths, in particular outside the active surface, have the same length. Since the feed and removal openings have substantially the same width as the first and second side, respectively, of the active surface, a high throughput of fluid can be achieved. This is advantageous, for example, in particular for the use of a line device according to the invention for conducting a cooling fluid for the fuel cell. In this case, the fuel cell can be cooled particularly readily and rapidly. Operation of the fuel cell within an ideal temperature range is therefore made possible in a particularly simple manner.

Furthermore, it can be provided in the case of the line device according to the invention that the feed section and the removal section are arrangeable on the active surface in such a manner that the feed opening is arrangeable perpendicularly or substantially perpendicularly to the first side of the active surface and the removal opening is arrangeable perpendicularly or substantially perpendicularly to the second side of the active surface, wherein the feed section and the removal section are arrangeable diagonally or substantially diagonally with respect to the active surface. It can thereby be ensured in particular that the feed section and the removal section lie outside the active surface such that there is no overlap between the active surface and the line sections. By means of the perpendicular arrangement of the feed opening to the first side, the fluid initially flows parallel to the first side and is distributed thereabove. For this purpose, for example, a collecting container can be arranged between the feed opening of the feed section and a first side of the active surface. The fluid subsequently flows perpendicularly to said outflow direction through the first side of the active surface into the active surface and, subsequently, out of the active surface again through the second side. After flowing out of the active surface, the fluid flows to the removal opening of the removal section which, in turn, is arranged perpendicularly with respect to the second side of the active surface. A collecting container can also be arranged here in turn between the second side of the active surface and the removal opening of the removal section. By means of these arrangements and in particular also by means of the arrangement of the feed section and of the removal section diagonally to the active surface, it can likewise be ensured that all of the possible flow paths are identical or substantially identical in length. As a result, all of the possible flow paths have approximately the same pressure drop, and therefore the fluid is uniformly distributed over the entire active surface. By means of the lateral arrangement of the feed section and of the removal section with respect to the active surface, the feed section and the removal section can be constructed in a particularly space-saving manner. This can be of advantage in particular in spatially restricted applications, such as, for example, portable and mobile applications of a fuel cell.

Furthermore, in the case of a line device according to the invention, it can be provided that the line device is designed for conducting a fuel fluid or a cooling fluid. In particular, all of the fluids required for operation of a fuel cell can be delivered to the fuel cell with a line device according to the invention. The various requirement conditions of the fluid used in each case can be entered into here by means of the various variant embodiments of a line device according to the invention. A particularly broad possibility of using a line device according to the invention is thereby provided.

According to a further aspect of the invention, the object is achieved by a fuel cell with an active surface and a line device, the line device at least having a feed section with a feed opening and a removal section with a removal opening, wherein the feed section is designed for supplying a fluid to a first side of the active surface of the fuel cell and the removal section is designed for removing a fluid from a second side of the active surface of the fuel cell and the fluid being able to flow along at least two flow paths from the feed opening through the active surface to the removal opening for the fluid. In particular, a fuel cell according to the invention is characterized in that the feed section and the removal section are arranged on the fuel cell in such a manner that the at least two flow paths are identical or substantially identical in length.

The identical or substantially identical lengths of the flow paths means that, at the flow paths which arise in particular without further line elements, the pressure drop along the flow path is likewise identical or substantially identical. The effect which can thereby be achieved is that the fluid will flow with the same degree of probability along all of the possible flow paths. A uniform provision of the fuel cell, in particular the active surface of the fuel cell, with fluid can therefore be ensured. Complicated line structures and/or distributing structures can thus be avoided. Collecting containers which can additionally be provided in each case between the feed section and/or the removal section and the active surface can be formed very simply and in particular without such line structures and/or distributing structures. By means of the arrangement according to the invention of the line device on the fuel cell, a fuel cell which can be produced particularly cost-effectively can therefore be provided.

Particularly preferably, in the case of a fuel cell according to the invention, it can be provided that the line device is configured according to the first aspect of the invention. All of the advantages which have been described with regard to a line device according to the first aspect of the invention will therefore, of course, also become apparent for a fuel cell according to the invention which has such a line device according to the first aspect of the invention.

Furthermore, in the case of a fuel cell according to the invention, it can be provided that a distributing structure is fitted between the feed section and the first side of the active surface and/or between the second side of the active surface and the removal section. By means of such a distributing structure, the uniformity of the lengths of the different flow paths can be increased even further. Owing to the fact that the different flow paths are already identical or substantially identical in length because of the arrangement in the line device, the distributing structure used can be configured particularly simply. For example, channels, lines and/or tubular bores are conceivable as the distributing structure, wherein a further equalization of the lengths of the different flow paths can already be achieved in this case with such a simple distributing structure. A particularly uniform provision of the active surface of the fuel cell with fluid can thereby be achieved.

Furthermore, in the case of a fuel cell according to the invention, it can be provided that the fuel cell is a polymer electrolyte fuel cell. A polymer electrolyte fuel cell here is a low-temperature fuel cell which in particular has a proton exchange membrane. In this context, the fluid supplied by the line device can be, in particular, oxygen, air, hydrogen and/or a cooling fluid. By means of the uniform distribution of the fluid in the active surface of the fuel cell by the arrangement according to the invention of the line device, particularly high efficiency of the fuel cell and effective cooling of the fuel cell can therefore be achieved. Of course, other types of fuel cell can also be provided in accordance with the design according to the invention with a line device. A particularly broad possibility of using a fuel cell according to the invention is thereby possible.

According to an additional aspect of the invention, the object is achieved by a fuel cell stack having at least two fuel cells. In particular, the fuel cell stack according to the invention is characterized in that at least one of the at least two fuel cells is designed according to the second aspect of the invention. All of the advantages which have been described with respect to a fuel cell according to the second aspect of the invention will therefore, of course, also become apparent for a fuel cell stack according to the invention which has at least one such fuel cell according to the second aspect of the invention.

### BRIEF DESCRIPTION OF THE DRAWINGS

The line device according to the invention and the developments thereof and also the advantages thereof, the fuel cell according to the invention and the developments thereof and also the advantages thereof, and the fuel cell stack according to the invention and the developments thereof and also the advantages thereof will be explained in more detail below with reference to drawings, in which, schematically:

FIG. 1 shows the prior art, as described in the introduction,

FIG. 2 shows a fuel cell according to the invention, and

FIGS. 3a, 3b, 3c show possible arrangements of a line device according to the invention on a fuel cell.

### DETAILED DESCRIPTION

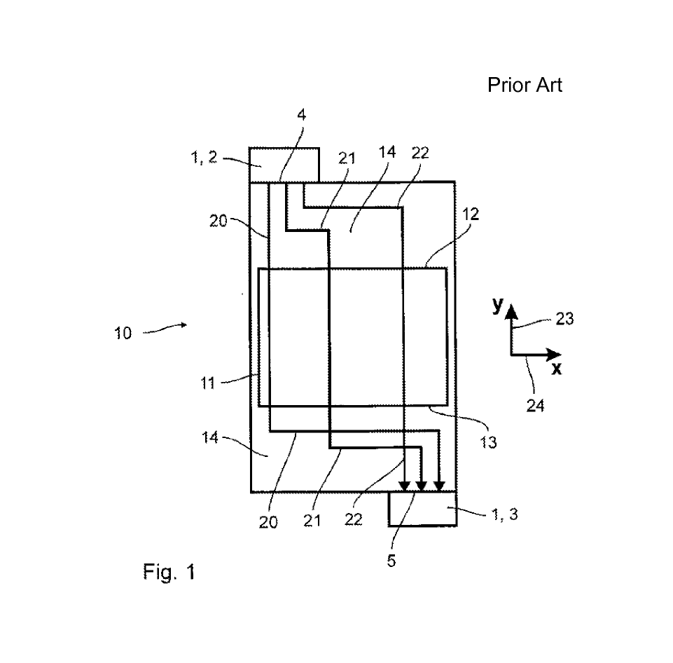

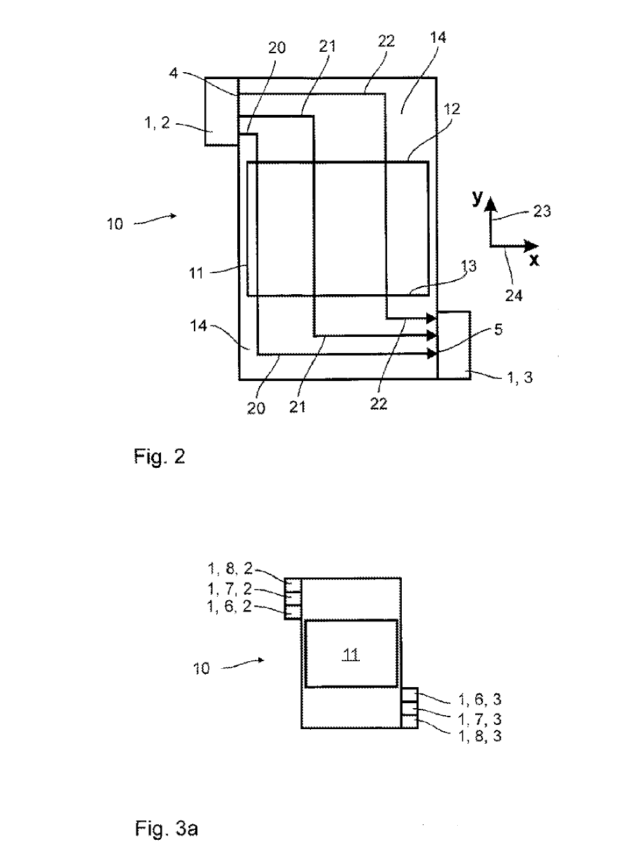

FIG. 2 shows a fuel cell 10 according to the invention. The fuel cell 10 here has, in particular, an active surface 11 with a first side 12 and a second side 13. The fuel cell 10 according to the invention is provided with a fluid by a line device 1. The fluid here can be, for example, a fuel, such as hydrogen, or a cooling fluid. The fluid flows here out of a feed opening 4 of the feed section 2 of the line device 1, enters through the first side 12 into the active surface 11 of the fuel cell 10 and flows through said surface. Subsequently, the fluid flows out of the second side 13 of the active surface 11 again and enters through the removal opening 5 into the removal section 3 of the line device 1 which transports the fluid away again. This flow between the feed section 2 and the removal section 3 can take place on different flow paths 20, 21, 22. Three of these possible flow paths 20, 21, 22 are drawn in on FIG. 2. According to the invention, the feed section 2 and the removal section 3 of the line device 1 are arranged with respect to the active surface 11 of the fuel cell 10 in such a manner that the length of the flow paths 20, 21, 22 is identical or substantially identical in length. The pressure drop along the flow paths 20, 21, 22 shown is thereby at least approximately the same size for each of the flow paths 20, 21, 22. Therefore, none of the flow paths 20, 21, 22 is preferred for the passage. The entire active surface 11 of the fuel cell 10 is therefore uniformly provided with the supplied fluid. The identical or substantially identical length of the flow paths 20, 21, 22 already arises here solely by means of the arrangement according to the invention of the feed section 2 and of the removal section 3 of the line device 1 with respect to the active surface 11. In particular, the length of the flow paths 20, 21, 22 in the X direction 24 is equalized here by the diagonal arrangement of the feed section 2 and of the removal section 3 in comparison to the exemplary embodiment of the prior art that is shown in FIG. 1. The distributing structures 14 which are likewise shown and are arranged both between the feed opening 4 and the first side 12 of the active surface 11 and between the second side 13 of the active surface 11 and the removal opening 5 can thereby be of particularly simple design. Complicated constructions of the distributing structures 14 can thus be avoided. The distributing structures 14 here can be formed, for example, by the simple arrangement of baffle plates. It is also conceivable for the distributing structures 14 to be formed by simple collecting containers in which the fluid is automatically distributed without further guidance. In summary, the arrangement according to the invention of a line device 1, in particular, in the exemplary embodiment shown, the diagonal arranging of a feed section 2 and of a removal section 3 with respect to the active surface 11 of a fuel cell, wherein the feed opening 4 of the feed section 2 and the removal opening 5 of the removal section 3 are in each case arranged perpendicularly to the first side 12 and to the second side 13, respectively, of the active surface 11, already ensures an equal size or substantially equal size of the length of the flow paths 20, 21, 22 and therefore uniform provision of the active surface 11 of the fuel cell with fluid. Furthermore, it can thereby be achieved that the feed section 2 and the removal section 3 lie outside the active surface 11, and therefore there is no overlap between the active surface 11 and the line sections 2, 3.

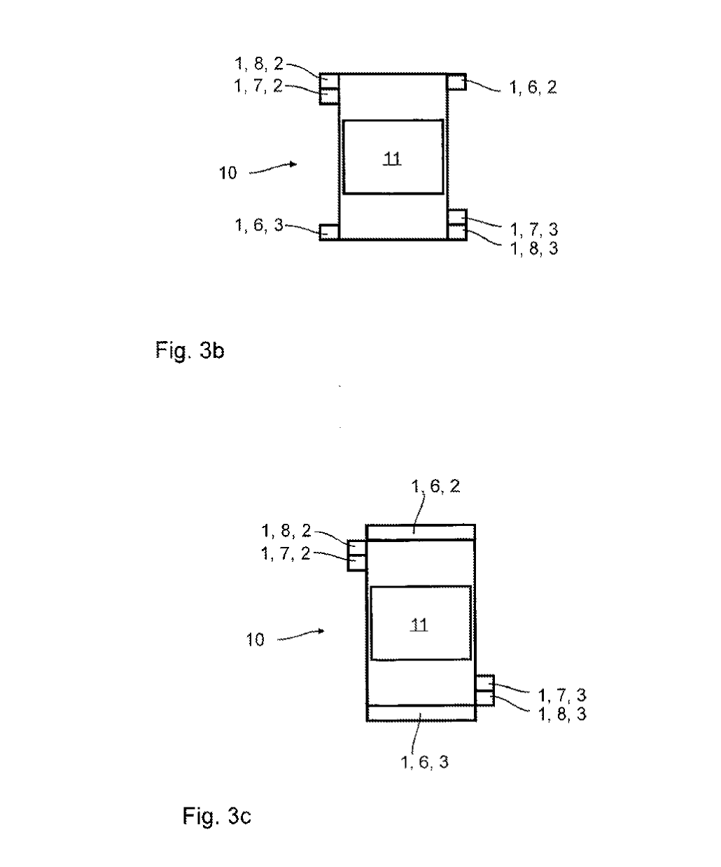

FIGS. 3a, 3b and 3c show various possibilities of arranging a feed section 2 and a removal section 3 of a line device 1 of a fuel cell 10. Each of the three figures here shows a line device 6 for air or oxygen, a line device 7 for a cooling fluid and a line device 8 for hydrogen. Of course, the fuel cell 10 here is constructed in such a manner that an unintentional mixing of the individual fluids can be avoided. FIG. 3a shows an arrangement of the line device 1, as has already been described in FIG. 2. All of the line devices 1 are arranged diagonally to the active surface 11 of the fuel cell 10. All of the advantages which have already been described in FIG. 2 arise, of course, for all three line devices 6, 7, 8. FIG. 3b shows a further possibility of arranging the line devices 1. All of the line devices 1 here are also arranged diagonally with respect to the active surface 11 of the fuel cell 10, wherein the line device 7 for the cooling fluid and the line device 8 for hydrogen are arranged together with respect to same diagonals, and the line device 6 for air is arranged with respect to a second diagonal of the active surface 11. Of course, a different division of the various line devices 6, 7, 8 is also conceivable. For example, a power supply 7 for the cooling fluid and the line device 8 for hydrogen could also be arranged on different diagonals with respect to the active surface 11. It can thus be ensured that a very wide variety of requirement specifications are taken into consideration. In FIG. 3c, in turn, the line devices 7 for the cooling fluid and 8 for hydrogen are arranged diagonally to the active surface 11 of the fuel cell 10. By contrast, the line device 6 for air is arranged with respect to the active surface 11 in such a manner that it is parallel to the active surface 11. The fluid, in this case air, of the line device 6 flows out over the entire width of the line device 6, as a result of which a very high volumetric throughput can be achieved. As a result, for example, it can therefore be ensured that the fuel cell 10 is particularly effectively provided with air or oxygen. Of course, any combination of the possibilities of arranging line devices 1 according to the invention on a fuel cell 10 that are shown in FIGS. 3a, 3b and 3c is conceivable. This makes it possible for a fuel cell 10 according to the invention to be designed specifically and adapted to a multiplicity of different requirements.

1. A line device (1) for a fuel cell (10), having at least one feed section (2) with a feed opening (4), and a removal section (3) with a removal opening (5), wherein the feed section (2) is designed for supplying a fluid to a first side (12) of an active surface (11) of the fuel cell (10) and the removal section (3) is designed for removing the fluid from a second side (13) of the active surface (11) of the fuel cell (10), and the fluid can flow along at least two flow paths (20, 21, 22) from the feed opening (4) through the active surface (11) to the removal opening (5) for the fluid, characterized in that the feed section (2) and the removal section (3) are arrangeable on the fuel cell (10) in such a manner that the at least two flow paths (20, 21, 22) are identical or substantially identical in length.

2. The line device (1) for a fuel cell (10) according to claim 1, characterized in that the feed opening (4) has the same or substantially the same width as the first side (12) of the active surface (11) and the removal opening (5) has the same or substantially the same width as the second side (13) of the active surface (11), and in that the feed section (2) and the removal section (3) are arrangeable on the active surface (11) in such a manner that the feed opening (4) is arrangeable parallel or substantially parallel to the first side (12) of the active surface (11) and the removal opening (5) is arrangeable parallel or substantially parallel to the second side (13) of the active surface (11).

3. The line device (1) for a fuel cell (10) according to claim 1, characterized in that the feed section (2) and the removal section (3) are arrangeable on the active surface (11) in such a manner that the feed opening (4) is arrangeable perpendicularly or substantially perpendicularly to the first side (12) of the active surface (11) and the removal opening (5) is arrangeable perpendicularly or substantially perpendicularly to the second side (13) of the active surface (11), wherein the feed section (2) and the removal section (3) are arrangeable diagonally or substantially diagonally with respect to the active surface (11).

4. The line device (1) for a fuel cell (10) according to claim 1, characterized in that the line device (1) is designed for conducting a fuel fluid.

5. The line device (1) for a fuel cell (10) according to claim 1, characterized in that the line device (1) is designed for conducting a cooling fluid.

6. A fuel cell (10) with an active surface (11) and a line device (1), the line device (1) at least having a feed section (2) with a feed opening (4), and a removal section (3) with a removal opening (5), wherein the feed section (2) is designed for supplying a fluid to a first side (12) of an active surface (11) of the fuel cell (10) and the removal section (3) is designed for removing the fluid from a second side (13) of the active surface (11) of the fuel cell (10), and the fluid can flow along at least two flow paths (20, 21, 22) from the feed opening (4) through the active surface (11) to the removal opening (5) for the fluid, characterized in that the feed section (2) and the removal section (3) are arranged on the fuel cell (10) in such a manner that the at least two flow paths (20, 21, 22) are identical or substantially identical in length.

7. The fuel cell (10) according to claim 6, characterized in that the feed opening (4) has the same or substantially the same width as the first side (12) of the active surface (11) and the removal opening (5) has the same or substantially the same width as the second side (13) of the active surface (11), and in that the feed section (2) and the removal section (3) are arrangeable on the active surface (11) in such a manner that the feed opening (4) is arrangeable parallel or substantially parallel to the first side (12) of the active surface (11) and the removal opening (5) is arrangeable parallel or substantially parallel to the second side (13) of the active surface (11).

8. The fuel cell (10) according to claim 6, characterized in that the feed section (2) and the removal section (3) are arrangeable on the active surface (11) in such a manner that the feed opening (4) is arrangeable perpendicularly or substantially perpendicularly to the first side (12) of the active surface (11) and the removal opening (5) is arrangeable perpendicularly or substantially perpendicularly to the second side (13) of the active surface (11), wherein the feed section (2) and the removal section (3) are arrangeable diagonally or substantially diagonally with respect to the active surface (11).

9. The fuel cell (10) according to claim 6, characterized in that the line device (1) is designed for conducting a fuel fluid.

10. The line device (1) for a fuel cell (10) according to claim 6, characterized in that the line device (1) is designed for conducting a cooling fluid.

11. The fuel cell (10) according to claim 6, characterized in that a distributing structure (14) is arranged between the feed section (2) and the first side (12) of the active surface (11) and between the second side (13) of the active surface (11) and the removal section (3).

12. The fuel cell (10) according to claim 6, characterized in that a distributing structure (14) is arranged between the feed section (2) and the first side (12) of the active surface (11).

13. The fuel cell (10) according to claim 6, characterized in that a distributing structure (14) is arranged between the second side (13) of the active surface (11) and the removal section (3).

14. The fuel cell (10) according to claim 6, characterized in that the fuel cell (10) is a polymer electrolyte fuel cell (10).

15. The fuel cell stack having at least two fuel cells (10), characterized in that at least one of the at least two fuel cells (10) is designed according to claim 6.
